(19) United States
(12) Patent Application Publication
(10) Pub. No.: US 2026/0116094 A1
(43) Pub. Date: Apr. 30, 2026

(54) SHEET CONVEYANCE APPARATUS AND IMAGE FORMING SYSTEM

(71) Applicant: CANON KABUSHIKI KAISHA, Tokyo (JP)

(72) Inventor: KAKERU TAKAHASHI, Tokyo (JP)

(21) Appl. No.: 19/351,935

(22) Filed: Oct. 7, 2025

(30) Foreign Application Priority Data
Oct. 25, 2024 (JP) 2024-188224

(51) Int. Cl. B41J 11/00; B41J 3/60; B41J 13/10; B41J 29/02

(52) U.S. Cl. CPC B41J 11/006; B41J 3/60; B41J 13/103; B41J 29/02

(57) ABSTRACT

A sheet conveyance apparatus includes an apparatus main body, a conveyance unit including a first conveyance unit that conveys a sheet in a first conveyance path, and a second conveyance unit that conveys a sheet in a second conveyance path and engages with the first conveyance unit, and a movement mechanism including a movement unit that supports the conveyance unit and moves between a stored position and an extracted position, wherein the first conveyance unit and the second conveyance unit are extracted out of the apparatus main body in a state engaged with each other when the conveyance unit moves from the stored position to the extracted position, and wherein the first conveyance unit and the second conveyance unit are dismountable from the movement unit separately from each other when the conveyance unit is extracted out to the extracted position.

### BACKGROUND

### Field of the Technology

The present disclosure relates to a sheet conveyance apparatus that conveys a sheet, and an image forming system to which this is applied.

### Description of the Related Art

Conventionally, sheet conveyance units for conveying sheets have been provided in image forming apparatuses.

Japanese Patent Laid-Open No. 2005-15175 describes a sheet conveyance unit that is mounted to the apparatus main body of an image forming apparatus so as to be slidable outward, thereby facilitating a jam clearance operation, maintenance work, and the like.

This sheet conveyance unit includes a first sheet transmission unit, a second sheet transmission unit, and a sheet guide unit integrally supported in the same housing, and this housing is configured to be drawable from the apparatus main body.

This configuration eliminates the necessity of individually drawing out the first sheet transmission unit, the second sheet transmission unit, and the sheet guide unit at the time of, for example, a jam clearance operation or maintenance work. In other words, this configuration allows these three units to be drawn out simultaneously by drawing out the sheet conveyance unit.

However, for example, in a case where each sheet transmission unit has a large size due to, for example, use of a large-size sheet in the image forming apparatus, the sheet conveyance unit supports a plurality of sheet transmission units in a single housing. In this case, the plurality of sheet transmission units is each supported in the same housing, and therefore positional misalignment may increase between the sheet transmission units. This positional misalignment between the sheet transmission units may impair the sheet conveyance performance.

### SUMMARY

The present disclosure is directed to providing a sheet conveyance apparatus and an image forming system that improve a sheet conveyance performance while improving workability of a jam clearance operation, maintenance work, and the like.

According to an aspect of the present disclosure, a sheet conveyance apparatus includes an apparatus main body, a conveyance unit including a first conveyance unit configured to convey a sheet in a first conveyance path, and a second conveyance unit configured to convey a sheet in a second conveyance path and engaged with the first conveyance unit, and a movement mechanism including a movement unit configured to support the conveyance unit and configured to move between a stored position where the conveyance unit is stored in the apparatus main body and an extracted position where the conveyance unit is extracted out of the apparatus main body, wherein the first conveyance unit and the second conveyance unit are extracted out of the apparatus main body in a state engaged with each other when the conveyance unit moves from the stored position to the extracted position, and wherein the first conveyance unit and the second conveyance unit are dismountable from the movement unit separately from each other when the conveyance unit is extracted out to the extracted position.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming system according to an embodiment.

FIG. 2A is a schematic perspective view illustrating a sheet feeding module according to the embodiment.

FIG. 2B is a schematic view illustrating the sheet feeding module according to the embodiment, and a front view illustrating a conveyance route.

FIG. 3 is a front view illustrating an apparatus main body of the sheet feeding module according to the embodiment.

FIG. 4 is a perspective view illustrating the apparatus main body of the sheet feeding module according to the embodiment as viewed from a front right side.

FIG. 5A is a perspective view of the apparatus main body of the sheet feeding module according to the embodiment as viewed from a front left side, illustrating an overall configuration.

FIG. 5B is a perspective view of the apparatus main body of the sheet feeding module according to the embodiment as viewed from the front left side, illustrating an enlarged view of a portion A.

FIG. 6A is a perspective view of the apparatus main body of the sheet feeding module according to the embodiment as viewed from a back left side, illustrating an overall configuration.

FIG. 6B is a perspective view of the apparatus main body of the sheet feeding module according to the embodiment as viewed from the back left side, illustrating an enlarged view of a portion B.

FIG. 7A is a perspective view of the apparatus main body of the sheet feeding module according to the embodiment, illustrating an overall configuration as viewed from the front left side.

FIG. 7B is a perspective view of the apparatus main body of the sheet feeding module according to the embodiment, illustrating an enlarged view of a portion C.

FIG. 7C is a perspective view of the apparatus main body of the sheet feeding module according to the embodiment, illustrating an overall configuration as viewed from the front right side.

FIG. 8A is a perspective view of the apparatus main body of the sheet feeding module according to the embodiment, illustrating an overall configuration as viewed from the front right side.

FIG. 8B is a perspective view of the apparatus main body of the sheet feeding module according to the embodiment, illustrating an overall configuration as viewed from the front left side.

### DESCRIPTION OF THE EMBODIMENTS

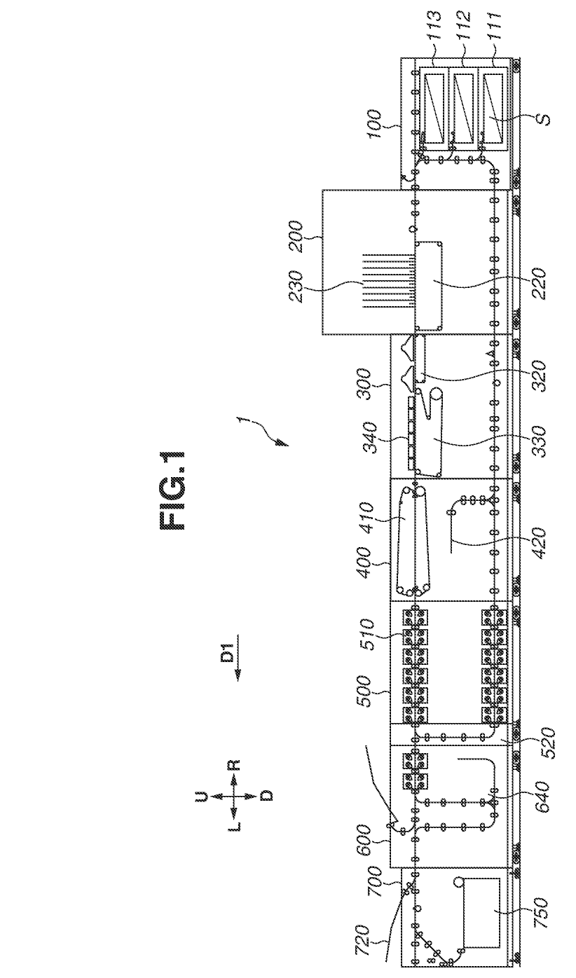

In the following description, an embodiment of the present disclosure will be described in detail with reference to FIGS. 1 to 4C. The present embodiment will be described citing an example in which an image forming system is applied to an inkjet recording system 1. FIG. 1 is a schematic view illustrating an example of the overall configuration of the inkjet recording system 1. This recording system 1 is a sheet-fed inkjet recording system that fabricates a recorded product by forming an ink image on a sheet S using two types of liquid: reaction liquid and ink. As illustrated in FIG. 1, the inkjet recording system 1 includes a sheet feeding module 100, a printing module 200, a drying module 300, a fixing module 400, a cooling module 500, a reversing module 600, and a discharge module 700. The sheet S in the form of cut paper, which is supplied from the sheet feeding module 100, is conveyed along a conveyance route, subjected to processing at each module, and discharged by the discharge module 700. The sheet in the present embodiment is a recording material, and includes paper such as a sheet and an envelope, a plastic film such as an overhead projector (OHP) sheet, a cloth, and the like. Further, in the present embodiment, a sheet conveyance direction D1 is arranged so as to extend in the leftward/rightward direction of the inkjet recording system 1, and a right side and a left side as viewed from the front, a front side, a back side, an upper side, and a lower side will be referred to as a rightward direction R, a leftward direction L, a forward direction F, a backward direction B, an upward direction U, and a downward direction D, respectively.

The sheet feeding module 100 is an example of a sheet conveyance apparatus that conveys the sheet S, is connected to the printing module 200 and conveys the sheet S, thereby supplying the sheet S to the printing module 200 and providing/receiving the sheet S to and from the printing module 200. The sheet feeding module 100 includes a first supply unit 111, a second supply unit 112, and a third supply unit 113 as sheet supply units that store and feed the sheet S. The first supply unit 111 includes a first storage unit 111a, which stores the sheet S, and a first sheet feeding unit 111b, which feeds the sheet S from the first storage unit 111a. The second supply unit 112 includes a second storage unit 112a, which stores the sheet S, and a second sheet feeding unit 112b, which feeds the sheet S from the second storage unit 112a. The third supply unit 113 includes a third storage unit 113a, which stores the sheet S, and a third sheet feeding unit 113b, which feeds the sheet S from the third storage unit 113a. The first storage unit 111a, the second storage unit 112a, and the third storage unit 113a are each configured to store a plurality of sheets, and are each configured to be drawn out to the apparatus front side. The sheet S is separated and fed one by one at the first storage unit 111a, the second storage unit 112a, or the third storage unit 113a by the first sheet feeding unit 111b, the second sheet feeding unit 112b, or the third sheet feeding unit 113b, and is conveyed to the printing module 200. The supply units are not limited to three supply units, and the sheet feeding module 100 may be configured to include one supply unit, two supply units, or four or more supply units. The sheet feeding module 100 will be described below.

The printing module 200 is an example of an image forming apparatus. The printing module 200 includes a not-illustrated pre-image formation registration correction unit, a print belt unit 220, and a recording unit 230, and conveys the sheet S. The sheet S conveyed from the sheet feeding module 100 is subjected to a correction of a skew and the position of the sheet S at the pre-image formation registration correction unit, and is conveyed to the print belt unit 220. The recording unit 230 is disposed at a position facing the print belt unit 220 with respect to the conveyance route. The recording unit 230 is an example of an image forming unit, and forms an image by performing recording processing (printing) on the sheet S using a recording head from above the conveyed sheet S. A plurality of recording heads is lined along the conveyance direction. The present embodiment includes five line-type recording heads in total, which correspond to four yellow (Y), magenta (M), cyan (C), and black (Bk) colors, and the reaction liquid. The number of colors and the number of recording heads are not limited to four and five, respectively. Examples employable as the inkjet method include a method using a heat generation element, a method using a piezoelectric element, a method using an electrostatic element, and a method using a microelectromechanical system (MEMS) element. Ink of each color is supplied from a not-illustrated ink tank to the recording head via an ink tube. The sheet S with the image printed thereon at the recording unit 230 is conveyed with a clearance maintained between the sheet S and the recording head by being adsorptively conveyed by the print belt unit 220. The sheet S with the image printed thereon at the recording unit 230 is subjected to detection of misregistration and a color density of the image formed on the sheet S by a not-illustrated in-line scanner disposed on a downstream side of the recording unit 230 in the sheet conveyance direction D1. A result of the detection is used to correct the printed image.

The drying module 300 includes a decoupling unit 320, a drying belt unit 330, and a warm air blowing unit 340, and enhances fixability between the sheet S and the ink by reducing a liquid amount contained in the ink provided onto the sheet S at the recording unit 230 of the printing module 200. The sheet S with the image printed thereon at the recording unit 230 of the printing module 200 is conveyed to the decoupling unit 320 disposed on an upstream side in the sheet conveyance direction D1 in the drying module 300. The decoupling unit 320 can convey the sheet S with the aid of a wind pressure applied from above and friction with the belt, and prevents displacement of the sheet S on the print belt unit 220 where the ink image is formed by conveying the sheet S on the belt while holding it lightly. The drying belt unit 330 and the warm air blowing unit 340 are disposed below and above the belt, respectively, thereby being disposed opposite from each other with the belt interposed therebetween. The sheet S conveyed from the decoupling unit 320 is conveyed while being adsorbed onto the drying belt unit 330, and an ink applied surface thereof is dried by receiving hot air from the warm air blowing unit 340 at the same time. The drying method may be configured by combining a method of irradiating the surface of the sheet S with an electromagnetic wave (ultraviolet light, infrared light, or the like) and/or a conductive heat transfer method using contact of a heat generation element, besides the method of applying hot air.

The fixing module 400 includes a fixing belt unit 410. The fixing belt unit 410 includes an upper belt unit and a lower belt unit, and can fix the ink onto the sheet S by causing the sheet S conveyed from the drying module 300 to pass through between the heated upper belt unit and lower belt unit.

The cooling module 500 includes a plurality of cooling units 510, and cools the high-temperature sheet S conveyed from the fixing module 400 via the sheet conveyance path. The cooling units 510 are each configured to cool the sheet S by introducing ambient air into a cooling box using a fan to increase the pressure in the cooling box, and applying wind blown out from a nozzle formed on a conveyance guide to the sheet S. The cooling units 510 are disposed both above and below the conveyance route, and cool the sheet S from both sides.

Further, the cooling module 500 includes a conveyance route switching unit 520, and can switch the conveyance route of the sheet S depending on a case in which the sheet S is conveyed to the reversing module 600 or a case in which the sheet S is conveyed to a two-sided conveyance route, which is used at the time of two-sided printing. At the time of two-sided printing, the sheet S is conveyed to a conveyance route in the lower portion of the cooling module 500. In this case, the sheet S is further conveyed from the cooling module 500 along the two-sided conveyance route of the fixing module 400, the drying module 300, the printing module 200, and the sheet feeding module 100. A first reversing unit 420 for reversing the front side and the back side of the sheet S is provided in the two-sided conveyance route of the fixing module 400. Then, the sheet S is, again, conveyed from the sheet feeding module 100 to the pre-image formation registration correction unit, the print belt unit 220, and the recording unit 230 of the printing module 200, and is subjected to printing at the recording unit 230.

The reversing module 600 includes a second reversing unit 640, which can reverse the front side and the back side of the conveyed sheet S, thereby changing the face-up/face-down orientation of the discharged sheet S. The discharge module 700 includes a top tray 720 and a sheet stacking unit 750, and the sheet S conveyed from the reversing module 600 is neatly stacked thereon.

### Sheet Feeding Module

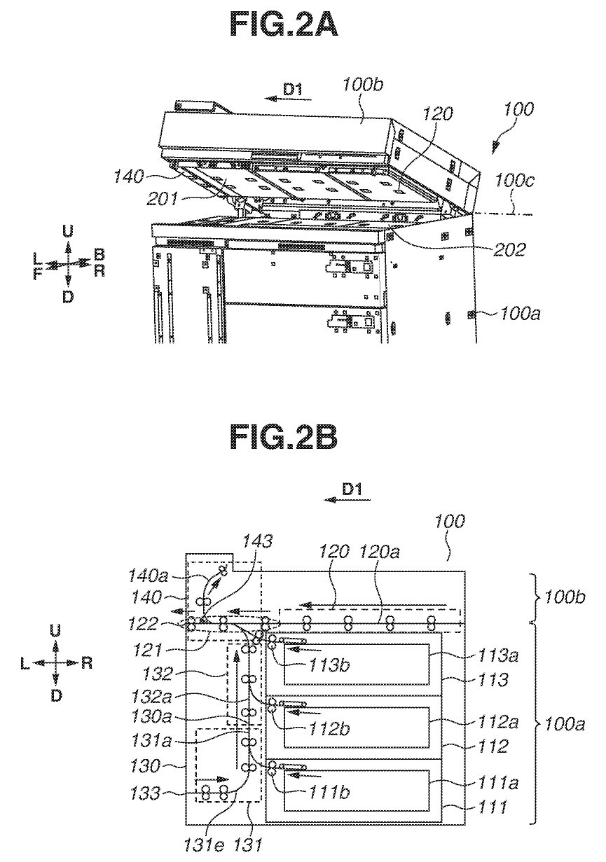

Next, the configuration of the sheet feeding module 100 will be described with reference to FIGS. 2A and 2B.

FIGS. 2A and 2B are front views illustrating the overall configuration of the conveyance route in the sheet feeding module 100.

As illustrated in FIGS. 2A and 2B, the sheet feeding module 100 includes an apparatus main body 100a, in which each supply unit is contained, and an upper door 100b, which is connected to the apparatus main body 100a with a hinge on the backward direction B side and is configured to be opened upward. The upper door 100b is supported rotatably about a rotational axis 100c relative to the apparatus main body 100a, and is displaceable between a closed position relative to the apparatus main body 100a (refer to FIG. 2B) and an opened position relative to the apparatus main body 100a (refer to FIG. 2A). In the present embodiment, the rotational axis 100c is arranged with an axial direction thereof extending in the sheet conveyance direction D1 of the conveyed sheet S. However, the axial direction of the rotational axis 100c is not limited to the sheet conveyance direction D1. Further, the arrows in FIG. 2B indicate a sheet conveyance direction of each conveyance route.

The sheet feeding module 100 includes a horizontal conveyance unit 120, a vertical conveyance unit 130, and an escape conveyance unit 140. The horizontal conveyance unit 120 includes a horizontally extending horizontal conveyance path 120a. The vertical conveyance unit 130 includes a vertical conveyance path 130a, which conveys the sheet S in the upward direction U. The escape conveyance unit 140 includes an escape conveyance path 140a, which conveys the sheet S in the upward direction U. A discharge route 121, which is formed by the upper portion of the vertical conveyance unit 130 and the lower portion of the escape conveyance unit 140, is continuously provided downstream of the horizontal conveyance path 120a in the sheet conveyance direction D1.

The vertical conveyance unit 130 is an example of a conveyance unit, and conveys the sheet S supplied from the first supply unit 111, the second supply unit 112, or the third supply unit 113 to the recording unit 230 (refer to FIG. 1). When the sheet S is supplied from the sheet feeding module 100 to the printing module 200 disposed downstream in the sheet conveyance direction D1, the following operation is performed. At the time of printing on a first surface of the sheet S, the sheet S is supplied from the first supply unit 111, the second supply unit 112, or the third supply unit 113. At the time of printing on a second surface of the sheet S, the sheet S is supplied through the vertical conveyance path 130a of the vertical conveyance unit 130 from a re-conveyance path (refer to FIG. 1) provided in the lower portion of the printing module 200 via a vertical conveyance inlet 133. The sheet S supplied in each case is conveyed from the discharge route 121 to the printing module 200 via a discharge port 122. The vertical conveyance unit 130 will be described below.

A switching unit 143 is provided in the discharge route 121. The switching unit 143 can switch the conveyance path by rotating, and switches whether to convey the sheet S conveyed in the discharge route 121 to the discharge port 122 or to the escape conveyance path 140a of the escape conveyance unit 140. When a jam or a malfunction occurs during printing, the switching unit 143 switches the conveyance route to the escape conveyance path 140a of the escape conveyance unit 140, thereby allowing the sheet S remaining in the conveyance route to a discharge tray provided in the upper portion of the sheet feeding module 100.

In the present embodiment, the escape conveyance unit 140 conveys the sheet S in the discharge route 121, which is an example of a third conveyance path. Further, the escape conveyance unit 140 is an example of the third conveyance unit, and is detachably mounted on the apparatus main body 100a, independently of the vertical conveyance unit 130.

The escape conveyance unit 140 receives and conveys the sheet S supplied from the third supply unit 113, and also conveys the sheet S conveyed in the discharge route 121 toward the recording unit 230.

### Vertical Conveyance Unit

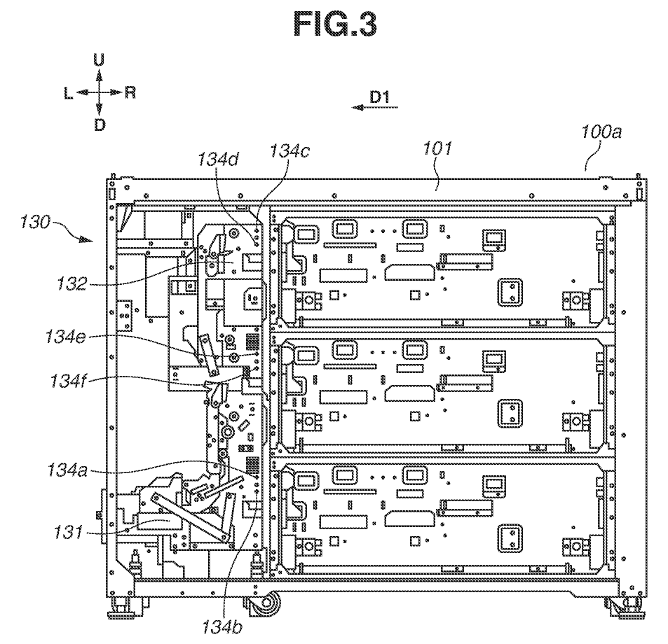

The vertical conveyance unit 130 will be described with reference to FIGS. 2B and 3. FIG. 3 is a front view of the apparatus main body 100a, which illustrates the details of a first conveyance unit 131 and a second conveyance unit 132. The vertical conveyance unit 130 includes the first conveyance unit 131 and the second conveyance unit 132. The first conveyance unit 131 receives the sheet S supplied from the first supply unit 111 and conveys it in a first conveyance path 131a. The second conveyance unit 132 receives the sheet S supplied from the second supply unit 112 and conveys it in a second conveyance path 132a. The second conveyance unit 132 is separably coupled to the first conveyance unit 131. The second conveyance unit 132 is disposed above the first conveyance unit 131. The coupling configuration will be described below.

The second conveyance path 132a is continuously connected to the first conveyance path 131a when the second conveyance unit 132 is coupled with the first conveyance unit 131. The discharge route 121 is continuously connected to the second conveyance path 132a when the escape conveyance unit 140 is mounted on the apparatus main body 100a. The first conveyance unit 131 includes a re-conveyance path 131e. The re-conveyance path 131e receives the sheet S via the vertical conveyance inlet 133 when the sheet S is conveyed again after passing through the recording unit 230, and conveys the sheet S to the first conveyance path 131a.

The apparatus main body 100a includes a frame 101. In the present embodiment, the frame 101 is defined as a substantially cuboidal frame member formed by connecting a plurality of rod-like frames.

The first conveyance unit 131 is placed in a state fixed to the forward direction F side of the frame 101 using screws 134a and 134b. The second conveyance unit 132 is placed in a state fixed to the forward direction F side of the frame 101 using screws 134c, 134d, 134e, and 134f.

### Movement Mechanism of Vertical Conveyance Unit

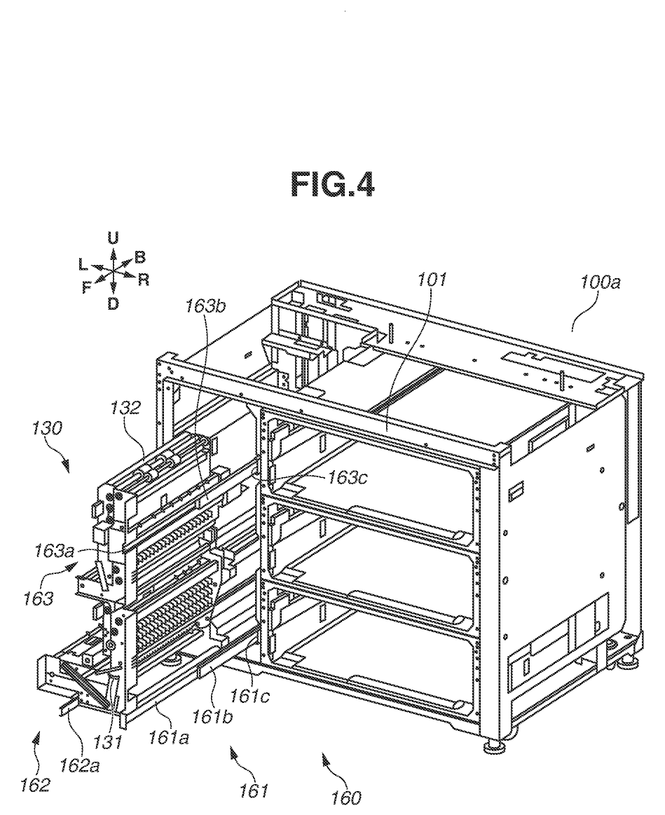

The vertical conveyance unit 130 is provided to be horizontally movable by a movement mechanism 160 to a stored position where the vertical conveyance unit 130 is stored in the apparatus main body 100a (refer to FIG. 2A), and to an extracted position where the vertical conveyance unit 130 is extracted out of the apparatus main body 100a (refer to FIG. 4). In the following description, the movement mechanism 160 will be described in detail with reference to FIG. 4. FIG. 4 is a perspective view illustrating the vertical conveyance unit 130 in the state extracted out of the apparatus main body 100a.

As illustrated in FIG. 4, the movement mechanism 160 includes a first mechanism 161, a second mechanism 162, and a third mechanism 163. The first mechanism 161 and the second mechanism 162 are disposed in the lower portion of a space within the frame 101, and are arranged in parallel with each other. The first mechanism 161 includes a first movement member 161a, a first assist rail 161b, and a first guide rail 161c. The first guide rail 161c is fixed to and supported by the frame 101 with its longitudinal direction extending in the forward/backward direction, and the substantially rod-like first assist rail 161b with its longitudinal direction extending in the forward/backward direction is provided on the first guide rail 161c so as to be slidable in the forward/backward direction. Further, the substantially rod-like first movement member 161a with its longitudinal direction extending in the forward/backward direction is provided slidably relative to the first assist rail 161b in the forward/backward direction. Therefore, the first movement member 161a is provided movably relative to the frame 101 in the forward/backward direction.

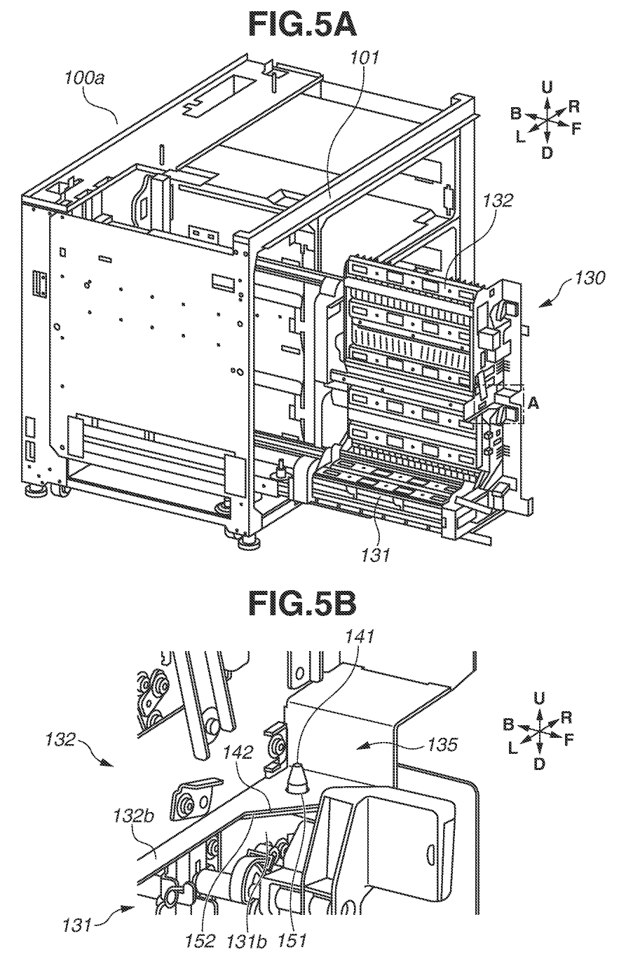

Similarly, the second mechanism 162 includes a second movement member 162a, a second assist rail 162b, and a second guide rail 162c. The second guide rail 162c is fixed to and supported by the frame 101 with its longitudinal direction extending in the forward/backward direction, and the substantially rod-like second assist rail 162b with its longitudinal direction extending in the forward/backward direction is provided on the second guide rail 162c slidably in the forward/backward direction (refer to FIG. 5A). Further, the substantially rod-like second movement member 162a with its longitudinal direction extending in the forward/backward direction is provided slidably relative to the second assist rail 162b in the forward/backward direction.

Therefore, the second movement member 162a is provided movably relative to the frame 101 in the forward/backward direction.

Then, the first movement member 161a and the second movement member 162a are an example of a movement unit and a first movement unit that support the vertical conveyance unit 130. Then, the first movement member 161a and the second movement member 162a are configured to be movable to the stored position where the vertical conveyance unit 130 is stored in the apparatus main body 100a, and to the extracted position where the vertical conveyance unit 130 is extracted out of the apparatus main body 100a. Further, the first guide rail 161c and the second guide rail 162c are an example of a guide unit that supports the first movement member 161a and the second movement member 162a and guide them to the apparatus main body 100a. In other words, the movement unit and the first movement unit include the first movement member 161a and the second movement member 162a, which are disposed in parallel with each other and configured to move between the stored position and the extracted position while each supporting the first conveyance unit 131.

Further, the third mechanism 163 includes a third movement member 163a, a third assist rail 163b, and a third guide rail 163c. The third guide rail 163c is fixed to and supported by the frame 101 with its longitudinal direction extending in the forward/backward direction, and the substantially rod-like third assist rail 163b with its longitudinal direction extending in the forward/backward direction is provided on the third guide rail 163c slidably in the forward/backward direction. Further, the substantially rod-like third movement member 163a with its longitudinal direction extending in the forward/backward direction is provided slidably relative to the third assist rail 163b in the forward/backward direction. Therefore, the third movement member 163a is provided movably relative to the frame 101 in the forward/backward direction. The third movement member 163a is an example of the movement unit and a second movement unit, and supports the second conveyance unit 132 and is configured to move between the stored position and the extracted position. Further, the third guide rail 163c is an example of the guide unit and a second guide unit, and supports the third movement member 163a and guides it relative to the apparatus main body 100a.

The first conveyance unit 131 is unfixed from the frame 101 by unscrewing the screws 134a and 134b. Similarly, the second conveyance unit 132 is unfixed from the frame 101 by unscrewing the screws 134c to 134f. The first conveyance unit 131 and the second conveyance unit 132 unfixed from the frame 101 are extracted while being kept in a state supported by the first movement member 161a, the second movement member 162a, and the third movement member 163a, which are movably provided on the frame 101. In the present embodiment, the vertical conveyance unit 130 is configured to be movably supported in the forward/backward direction by the movement mechanism 160, so that it can be extracted in the forward direction F and mounted in the backward direction B. In other words, the vertical conveyance unit 130 is extracted out of the apparatus main body 100a in the forward direction F, which is a first direction and a horizontal direction, when the first movement member 161a, the second movement member 162a, and the third movement member 163a move from the stored position to the extracted position. Accordingly, the vertical conveyance unit 130 is configured to be held on the forward direction F side of the apparatus main body 100a before being dismounted from the apparatus main body 100a.

### Dividable Configuration of Vertical Conveyance Unit

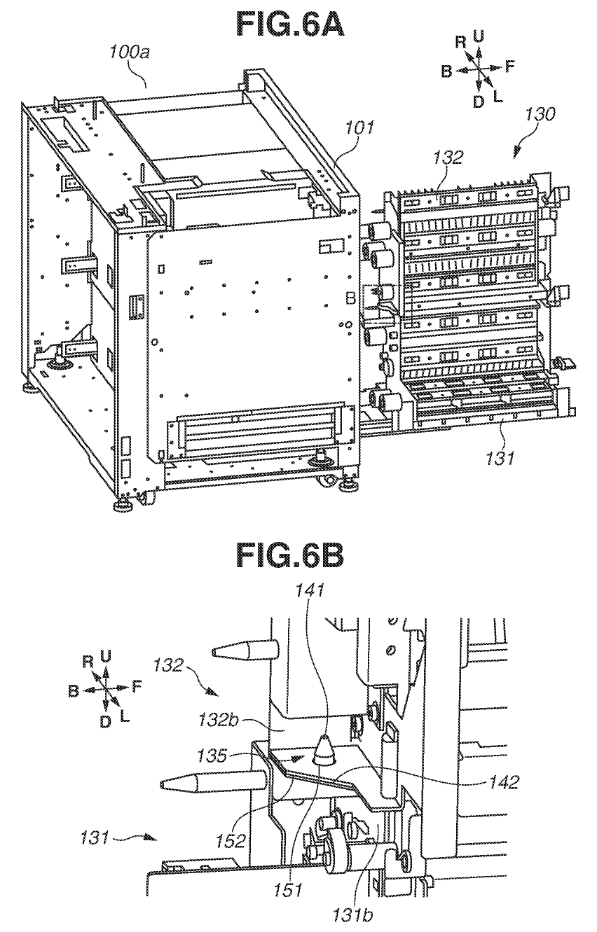

Next, the dividable configuration of the vertical conveyance unit 130 will be described with reference to FIGS. 5A to 8B. FIGS. 5A to 6A are perspective views illustrating the first conveyance unit 131 and the second conveyance unit 132 in the state coupled with each other. FIG. 5A is an overall perspective view as viewed from the front left side. FIG. 5B is an enlarged view of a portion A illustrated in FIG. 5A. FIG. 6A is an overall perspective view as viewed from the back left side. FIG. 6B is an enlarged view of a portion B illustrated in FIG. 6A. In the present embodiment, the first conveyance unit 131 and the second conveyance unit 132 are coupled with each other horizontally while being separable from each other vertically in the state that they are coupled with each other.

The vertical conveyance unit 130 includes coupling units 135, which couple the first conveyance unit 131 and the second conveyance unit 132. The coupling unit 135 are disposed on the front side and the back side of the vertical conveyance unit 130, respectively.

These respective coupling units 135 on the front side and the back side are configured symmetrically to each other in the forward/backward direction, and therefore will be described assigning the same reference numerals to their corresponding members. FIG. 5B illustrates the coupling unit 135 on the front side, and FIG. 6B illustrates the coupling unit 135 on the back side.

The coupling unit 135 includes a pin portion 141 and a supporting surface 142 disposed on the first conveyance unit 131, and a hole portion 151 and a supported surface 152 disposed on the second conveyance unit 132. The pin portion 141 and the supporting surface 142 are formed on a frame 131b of the first conveyance unit 131. The hole portion 151 and the supported surface 152 are formed on a frame 132b of the second conveyance unit 132.

The pin portion 141 has a vertically extending shape. The hole portion 151 is shaped to allow the pin portion 141 to be attachable and detachable in a vertical direction, and is formed by a through-hole that penetrates through the frame 132b vertically in the present embodiment.

However, the hole portion 151 is not limited to a through-hole, and may be a recessed portion including a bottom surface. The supported surface 152 supports at least a part of the weight of the second conveyance unit 132 by coming into contact with the supporting surface 142.

Due to this configuration, the coupling unit 135 restricts the second conveyance unit 132 from moving relative to the first conveyance unit 131 in the forward direction F and the backward direction B with the aid of the engagement between the pin portion 141 and the hole portion 151 when the second conveyance unit 132 is coupled with the first conveyance unit 131. Further, the coupling unit 135 is configured to allow the second conveyance unit 132 to be decoupled from the first conveyance unit 131 in the upward direction U. The upward direction U is an example of a second direction, and is a direction intersecting with the forward direction F, which is the first direction. In other words, the vertical conveyance unit 130 is extracted out of the apparatus main body 100a with the first conveyance unit 131 and the second conveyance unit 132 coupled with each other when the movement unit moves from the stored position to the extracted position. With the aid of the coupling unit 135, the present embodiment allows the first conveyance unit 131 and the second conveyance unit 132 to be extracted in the forward direction F of the apparatus main body 100a all at once, thereby being able to reduce a time spent for maintenance compared to when the first conveyance unit 131 and the second conveyance unit 132 are extracted separately.

Further, in the present embodiment, the coupling unit 135 positions the second conveyance unit 132 relative to the first conveyance unit 131 in the forward/backward direction in such a manner that the second conveyance path 132a is continuously connected to the first conveyance path 131a. Due to that, the vertical conveyance path 130a can be ensured.

The coupling unit 135 is configured to include the pin portion 141 provided on the first conveyance unit 131 and the hole portion 151 provided on the second conveyance unit 132 in the present embodiment, but is not limited thereto. For example, the coupling unit 135 may be configured to include a hole portion provided on the first conveyance unit 131 and a pin portion provided on the second conveyance unit 132. In other words, the coupling unit 135 is not limited to the present example as long as the pin portion 141 is provided on one of the first conveyance unit 131 and the second conveyance unit 132, and the hole portion 151 is provided on the other of the first conveyance unit 131 and the second conveyance unit 132. Alternatively, the engagement configuration is not limited to the pin portion 141 and the hole portion 151, and may be realized by employing a commonly-used engagement configuration having contact portions that engage with each other.

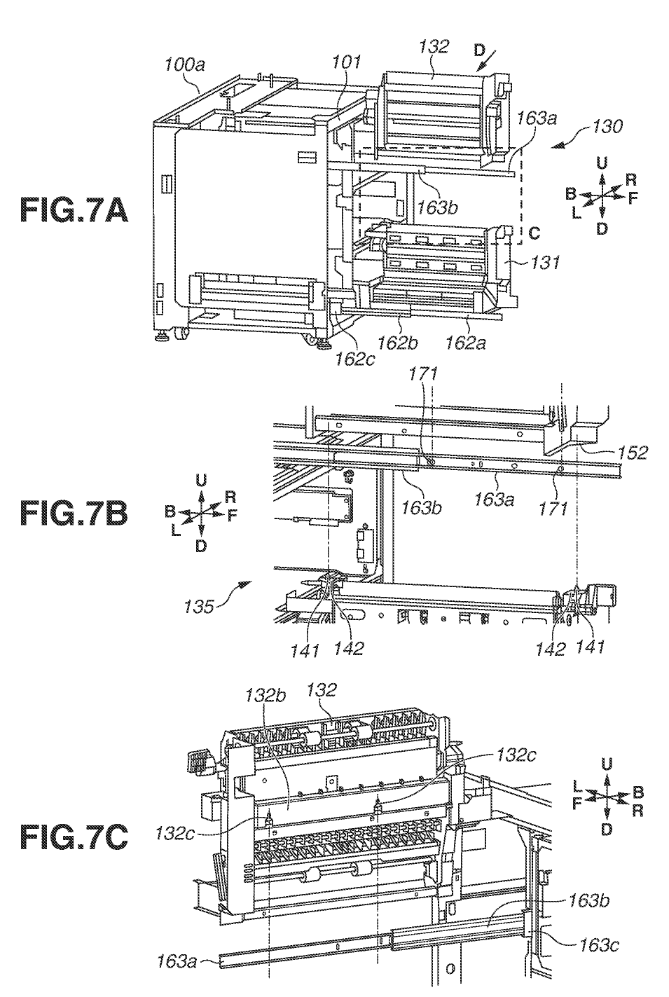

Next, a configuration for dismounting the second conveyance unit 132 from the apparatus main body 100a will be described with reference to FIGS. 7A to 7C. FIG. 7A is an overall perspective view. FIG. 7B is an enlarged view of a portion C illustrated in FIG. 7A. FIG. 7C is a perspective view as viewed from the direction D (indicated by arrow) illustrated in FIG. 7A. As illustrated in FIG. 7B, the third movement member 163a is provided with two rivet pins 171 spaced apart in the forward/backward direction on the side surface on the left side. Each of the rivet pins 171 protrudes from the left side surface of the third movement member 163a in the leftward direction L, and is shaped to have a flaring tip portion. On the other hand, as illustrated in FIG. 7C, groove portions 132c are formed at two positions spaced apart in the forward/backward direction, respectively, on the right side surface of the frame 132b of the second conveyance unit 132. Each of the groove portions 132c is shaped to be opened in the downward direction D and extend in the upward direction U. The groove portions 132c are configured to support the weight of a part of the second conveyance unit 132 by being engaged with the rivet pins 171 when the second conveyance unit 132 is coupled with the first conveyance unit 131. However, the groove portions 132c may not necessarily support the weight of a part of the second conveyance unit 132, and, in this case, the groove portions 132c function to support the second conveyance unit 132 so as to prevent it from tilting in the leftward/rightward direction.

The second conveyance unit 132 is configured to be dismounted by being pulled up in the upward direction U in the state extracted in the forward direction F of the apparatus main body 100a together with the first conveyance unit 131. When the second conveyance unit 132 is pulled up in the upward direction U, the groove portions 132c are disengaged from the rivet pins 171. Further, the second conveyance unit 132, whose supported surface 152 is supported by the supporting surface 142 of the first conveyance unit 131, is configured to be easily decoupled without engagement between the pin portions 141 and the hole portions 151. In other words, the coupling units 135 are not in an engaged state with the second conveyance unit 132 in the upward direction U, in which the second conveyance unit 132 is dismounted.

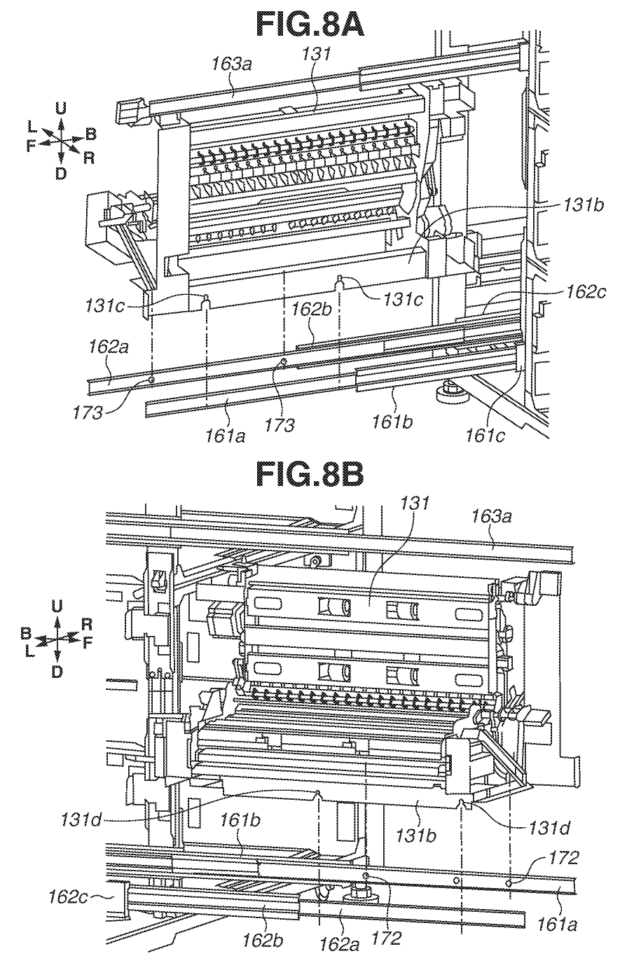

Next, a configuration for dismounting the first conveyance unit 131 from the apparatus main body 100a will be described with reference to FIGS. 8A and 8B. FIG. 8A and 8B are perspective views illustrating the configuration for dismounting the first conveyance unit 131 from the apparatus main body 100a. FIG. 8A is a perspective view as viewed from the front right side, and FIG. 8B is a perspective view as viewed from the front left side. As illustrated in FIG. 8B, the first movement member 161a is provided with two rivet pins 172 spaced apart in the forward/backward direction on the side surface on the left side. Each of the rivet pins 172 protrudes from the left side surface of the first movement member 161a in the leftward direction L, and is shaped to have a flaring tip portion. Further, as illustrated in FIG. 8A, the second movement member 162a is provided with two rivet pins 173 spaced apart in the forward/backward direction on the side surface on the right side. Each of the rivet pins 173 protrudes from the right side surface of the second movement member 162a in the rightward direction R, and is shaped to have a flaring tip portion.

On the other hand, as illustrated in FIG. 8A, groove portions 131c are formed at two positions spaced apart in the forward/backward direction on the right side surface of the frame 131b of the first conveyance unit 131. Each of the groove portions 131c is shaped to be opened in the downward direction D and extend in the upward direction U. The groove portions 131c are configured to support the weight of a part of the first conveyance unit 131 by being engaged with the rivet pins 172 when the first conveyance unit 131 is mounted on the apparatus main body 100a. Further, as illustrated in FIG. 8B, groove portions 131d are formed at two positions spaced apart in the forward/backward direction on the left side surface of the frame 131b of the first conveyance unit 131. Each of the groove portions 131d is shaped to be opened in the downward direction D and extend in the upward direction U. The groove portions 131d are configured to support the weight of a part of the first conveyance unit 131 by being engaged with the rivet pins 173 when the first conveyance unit 131 is mounted on the apparatus main body 100a.

The first conveyance unit 131 is configured to be dismounted by being pulled up in the upward direction U after the second conveyance unit 132 is dismounted. When the first conveyance unit 131 is pulled up in the upward direction U, the groove portions 131c and the groove portions 131d are disengaged from the rivet pins 172 and the rivet pins 173, respectively, allowing the first conveyance unit 131 to be easily dismounted. In other words, the vertical conveyance unit 130 is configured in such a manner that the first conveyance unit 131 and the second conveyance unit 132 can be dismounted from the apparatus main body 100a separably from each other when the movement unit is extracted out to the extracted position. Further, when the movement unit is extracted out to the extracted position, the second conveyance unit 132 can be separated from the first conveyance unit 131 and dismounted in the upward direction U, and the first conveyance unit 131 can be dismounted from the first movement member 161a and the second movement member 162a in the upward direction U. The second conveyance unit 132 is dismounted first and then the first conveyance unit 131 is dismounted in the present embodiment. However, without being limited thereto, the sheet feeding module 100 can also be configured in such a manner that the first conveyance unit 131 and the second conveyance unit 132 are dismounted at the same time.

On the other hand, when the dismounted vertical conveyance unit 130 is mounted onto the apparatus main body 100a, the first movement member 161a and the second movement member 162a are positioned at the extracted position, and the first conveyance unit 131 is placed in the downward direction D. At this time, the first conveyance unit 131 can be supported by the first movement member 161a and the second movement member 162a by engaging the groove portions 131c with the rivet pins 172 and the groove portions 131d with the rivet pins 173. Further, the second conveyance unit 132 is placed from above the first conveyance unit 131 in the downward direction D. At this time, the second conveyance unit 132 can be supported by the first conveyance unit 131 by engaging the groove portions 132c with the rivet pins 172 and the pin portions 141 with the hole portions 151. As a result, the first conveyance unit 131 and the second conveyance unit 132 are coupled with each other, thereby constituting the vertical conveyance unit 130. The vertical conveyance unit 130 can be stored in the apparatus main body 100a by moving it in the backward direction B in this state.

As described above, according to the present embodiment, the vertical conveyance unit 130 is configured in such a manner that the first conveyance unit 131 and the second conveyance unit 132 can be dismounted from the apparatus main body 100a separably from each other when the first movement member 161a and the second movement member 162a are extracted out to the extracted position. Therefore, the present embodiment can reduce the weight of a member to be lifted up compared to when the vertical conveyance unit 130 is dismounted as a single unit, thereby improving workability at the time of a jam clearance operation, maintenance work, and the like.

In other words, the first conveyance unit 131 and the second conveyance unit 132 are not supported in the same housing unlike the conventional technique despite the fact that the first conveyance unit 131 and the second conveyance unit 132 can be extracted out of the apparatus main body 100a all at once. Therefore, the vertical conveyance unit 130 may not necessarily be lifted up by a plurality of workers even when the weight of the sheet conveyance unit is heavy. As a result, the time to be spent for maintenance can be curtailed.

The above-described embodiment has been described citing the example in which the vertical conveyance unit 130 is configured to be separable into two conveyance units. However, the vertical conveyance unit 130 is not limited thereto and may be configured to be separable into three or more units, each of which can be individually dismounted from the apparatus main body 100a. In this case, the plurality of conveyance units is configured to be extracted out of the apparatus main body 100a in the state coupled with each other when the movement unit moves from the stored position to the extracted position, and is configured to be dismounted from the movement unit in the state separated from each other when the movement unit is located at the extracted position. As a result, the present configuration is applicable to, for example, when the sheet conveyance section of the first conveyance unit 131 and the second conveyance unit 132 is divided into three or more conveyance units in a case where the vertical conveyance unit 130 has a large size due to, for example, a further increase in the sheet size according to the specifications. In this case, the present configuration can be achieved by allowing each of the plurality of conveyance units to be extracted all at once and providing each of the conveyance units with an engagement unit that engages them only in the extraction direction and does not engage them in the dismounting direction.

Further, the above-described embodiment has been described assuming that the extraction direction is the forward direction F or the horizontal direction and the dismounting direction is the upward direction U, but the extraction and dismounting directions are not limited to these examples and may be other directions. For example, the extraction direction may be the forward direction F and the dismounting direction may also be the forward direction F.

Further, the above-described embodiment has been described citing the example in which the first conveyance path 131a and the second conveyance path 132a are continuous in the vertical conveyance unit 130, but the vertical conveyance unit 130 is not limited thereto. For example, the present configuration may be applied even when the first conveyance path 131a and the second conveyance path 132a are not continuous. Further, the vertical conveyance unit 130 uses two mechanisms, the first mechanism 161 and the second mechanism 162, as the movement mechanism supporting the first conveyance unit 131 in the above-described embodiment, but is not limited thereto. For example, the vertical conveyance unit 130 may be configured to support the first conveyance unit 131 using one mechanism or three or more mechanisms.

Further, in the above-described embodiment, the configuration has been described as applied to the sheet feeding module 100 as an example of the sheet conveyance apparatus, but is not limited thereto. For example, the configuration may be applied to the printing module 200, or may be applied to another module such as the reversing module 600 or the discharge module 700. Further, the sheet conveyance apparatus can be applied to an inspection apparatus that reads out an image on a sheet after image formation to inspect it, an automatic document feeder that feeds a document to read out an image therefrom.

Further, the above-described embodiment has been described citing the example in which the image forming system is applied to the inkjet recording system 1 of the inkjet recording method, but the image forming system is not limited thereto and may be applied to an electrophotographic image forming apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-188224, filed October 25, 2024, which is hereby incorporated by reference herein in its entirety.

What is claimed is:

1. A sheet conveyance apparatus comprising:
an apparatus main body;
a conveyance unit including a first conveyance unit configured to convey a sheet in a first conveyance path, and a second conveyance unit configured to convey a sheet in a second conveyance path and engaged with the first conveyance unit; and
a movement mechanism including a movement unit configured to support the conveyance unit, the movement unit being configured to move between a stored position where the conveyance unit is stored in the apparatus main body and an extracted position where the conveyance unit is extracted out of the apparatus main body,
wherein the first conveyance unit and the second conveyance unit are extracted out of the apparatus main body in a state engaged with each other when the conveyance unit moves from the stored position to the extracted position, and
wherein the first conveyance unit and the second conveyance unit are dismountable from the movement unit separately from each other when the conveyance unit is extracted out to the extracted position.

2. The sheet conveyance apparatus according to claim 1, wherein the conveyance unit is extracted out of the apparatus main body in a first direction when the conveyance unit moves from the stored position to the extracted position, and
wherein the second conveyance unit is separable and dismountable from the first conveyance unit in a second direction intersecting with the first direction and the first conveyance unit is dismountable from the movement unit in the second direction, when the conveyance unit is extracted out to the extracted position.

3. The sheet conveyance apparatus according to claim 2, wherein the second conveyance unit is disposed above the first conveyance unit,
wherein the first direction is a horizontal direction, and
wherein the second direction is an upward direction.

4. The sheet conveyance apparatus according to claim 3, wherein the movement mechanism includes a guide unit configured to support and guide the movement unit relative to the apparatus main body, and
wherein the movement unit supports the first conveyance unit, and is provided to be movable between the stored position and the extracted position.

5. The sheet conveyance apparatus according to claim 4, wherein the movement unit includes a first movement member and a second movement member disposed in parallel with each other and provided to be movable between the stored position and the extracted position while each is configured to support the first conveyance unit.

6. The sheet conveyance apparatus according to claim 4, wherein the movement unit is a first movement unit, and the guide unit is a first guide unit, and
wherein the movement mechanism includes
a second movement unit configured to support the second conveyance unit that is provided to be movable between the stored position and the extracted position, and
a second guide unit configured to support and guide the second movement unit relative to the apparatus main body.

7. The sheet conveyance apparatus according to claim 1, further comprising:
a first supply unit including a first storage unit configured to store the sheet, and a first sheet feeding unit configured to feed the sheet from the first storage unit; and
a second supply unit including a second storage unit configured to store the sheet, and a second sheet feeding unit configured to feed the sheet from the second storage unit,
wherein the first conveyance unit receives and conveys the sheet supplied from the first supply unit, and
wherein the second conveyance unit receives and conveys the sheet supplied from the second supply unit.

8. The sheet conveyance apparatus according to claim 7, further comprising:
a third conveyance unit configured to convey a sheet in a third conveyance path, and detachably mounted on the apparatus main body independently of the conveyance unit; and
a third supply unit including a third storage unit configured to store the sheet and a third sheet feeding unit configured to feed the sheet from the third storage unit,
wherein the second conveyance path is continuously connected to the first conveyance path when the second conveyance unit is coupled with the first conveyance unit,
wherein the third conveyance path is continuously connected to the second conveyance path when the third conveyance unit is mounted on the apparatus main body, and
wherein the third conveyance unit receives and conveys the sheet supplied from the third supply unit, and conveys the sheet from the third conveyance path toward an image forming unit configured to form an image on the sheet.

9. The sheet conveyance apparatus according to claim 8, wherein the first conveyance unit includes a re-conveyance path for conveying the sheet to the first conveyance path after the sheet has moved through the image forming unit.

10. The sheet conveyance apparatus according to claim 2, wherein the conveyance unit includes a coupling unit configured to couple the first conveyance unit and the second conveyance unit, and
wherein the coupling unit is configured to restrict the second conveyance unit from moving relative to the first conveyance unit in the first direction and allow the second conveyance unit to be decoupled from the first conveyance unit in the second direction, when the second conveyance unit is coupled with the first conveyance unit.

11. The sheet conveyance apparatus according to claim 10, wherein the second conveyance path is continuously connected to the first conveyance path when the second conveyance unit is coupled with the first conveyance unit, and
wherein the coupling unit positions the second conveyance unit relative to the first conveyance unit in the first direction in such a manner that the second conveyance path is continuously connected to the first conveyance path.

12. The sheet conveyance apparatus according to claim 10, wherein the second conveyance unit is disposed above the first conveyance unit,
wherein the first direction is a horizontal direction, and
wherein the second direction is an upward direction.

13. The sheet conveyance apparatus according to claim 12, wherein the coupling unit includes
a pin portion disposed on one of the first conveyance unit and the second conveyance unit and having a vertically extending shape,
a hole portion disposed on the other of the first conveyance unit and the second conveyance unit and configured to allow the pin portion to be attached and detached in a vertical direction,
a supporting surface disposed on the first conveyance unit, and
a supported surface disposed on the second conveyance unit and configured to support at least a part of a weight of the second conveyance unit by coming into contact with the supporting surface.

14. A sheet conveyance apparatus comprising:
an apparatus main body;
a conveyance unit including a plurality of conveyance units configured to convey a sheet; and
a movement unit configured to support the conveyance unit, the movement unit being configured to be movable between a stored position where the conveyance unit is stored in the apparatus main body and an extracted position where the conveyance unit is extracted out of the apparatus main body,
wherein the plurality of conveyance units is extracted out of the apparatus main body in a state coupled with each other when the movement unit moves from the stored position to the extracted position, and
wherein the plurality of conveyance units is dismountable from the movement unit in a state separated from each other when the movement unit is located at the extracted position.

15. An image forming system comprising:
an image forming apparatus including an image forming unit configured to form an image on a sheet; and
the sheet conveyance apparatus according to claim 1.
